(19) United States
(12) Patent Application Publication
(10) Pub. No.: US 2007/0297855 A1
(43) Pub. Date: Dec. 27, 2007

(54) Method For Primary Molding Of A Molded Part, And Molded Part Produced By Primary Molding, In Particular Nut

(76) Inventors: Wolfgang Gerlach, Biebertal (DE); Jens Albach, Hungen (DE)

Correspondence Address: HARNESS, DICKEY & PIERCE, P.L.C., P.O. BOX 828, BLOOMFIELD HILLS, MI, 48303, US

(21) Appl. No.: 11/832,964

(22) Filed: Aug. 2, 2007

Related U.S. Application Data
(63) Continuation of application No. PCT/EP2006/050728, filed on Feb. 7, 2006.

(30) Foreign Application Priority Data
Feb. 11, 2005 (DE) 10 2005 006 592.9

(51) Int. Cl. F16D 1/00

(52) U.S. Cl. 403/408.1

(57) ABSTRACT

In a method for primary molding of a molded part having an opening and an internal thread formed in the opening, segments of a course of the inner thread arranged in two different sectors of the opening are formed by molding cores projecting into the opening. For release from the mold, the mold cores are withdrawn from the molded part radially with respect to the longitudinal axis of the internal thread. A molded part produced according to the method has an opening and, formed in the opening, an internal thread that has segments of a course of thread located in different sectors of the opening, wherein one core opening is opposite each segment of the internal thread, which opening penetrates the wall of the molded part radially outward.

### CROSS-REFERENCE TO RELATED APPLICATIONS

This application is a continuation of International Application No. PCT/EP2006/050728, filed Feb. 7, 2006, which claims the benefit of German Patent Application No. 10 2005 006 592.9, filed Feb. 11, 2005. The disclosures of the above applications are incorporated herein by reference.

### FIELD

The invention concerns a method for primary molding of a molded part having an opening and, formed in the opening, an internal thread that has at least two segments of a course of thread located in different sectors, wherein the segments of the internal thread are formed by molding cores projecting into the opening. The invention also concerns a molded part produced with such a method, in particular a nut.

### BACKGROUND

In the primary molding of small quantities of plastic molded parts, it is known to form internal threads by means of lost cores placed in the injection molding die; after the molding process, these lost cores are released from the mold along with the molded part. Once outside the mold, the core must be unscrewed from the molded part in a costly manner. It is also known to use collapsible cores to form internal threads. In this method, the core is divided into segments, and the thread is released by moving the segments in a radial direction after the molding process. Easily removable mold cores with angled slides can be used in the manufacture of segmented threads. Both the aforementioned solutions have the disadvantage that they require complicated and costly mold cores.

From DE-A1-4,004,550 is known a molded part that has an internal thread and is assembled from two base bodies, with the plane of separation passing through the central axis of the internal thread. As a result, the cylindrical, open internal threads of the base bodies are easy to release from the mold. However, the assembly of the base bodies entails additional costs and strength problems.

In order to avoid the aforementioned problems, it is further known to provide primary molded plastic nuts with a smooth, inside bore that has an inwardly tapering conical lead-in area. The inside diameter of the bore is dimensioned such that screwing the nut onto a threaded stud forms a thread in the bore of the nut. A plastic nut of this nature is known from EP-B1-0,554,094. This known plastic nut additionally has, in the lead-in area of the smooth bore, a stripping zone composed of a plurality of parallel tubular cavities. These cavities intersect with the walls of the bore of the nut, forming cutting edges which are intended to scrape the surface of a stud being screwed in and remove deposits. Adjacent cavities are joined by connecting cavities that accommodate the material stripped from the threaded stud. Plastic nuts with a smooth bore have the disadvantage that they are subjected to higher stress and require higher torques during assembly. The axial load capacity is lower than that of plastic nuts with premolded threads.

In addition, a thread-cutting hex nut is known from DE-A-2,058,316 in which two holes are bored in the nut from opposite flats near one end face, and cut the thread of the nut. The holes run parallel to one another and are offset from the center axis of the nut, by which means cutting edges for cutting thread courses are formed at the intersections between the holes and the thread. This nut is not suitable for simple manufacture by primary molding.

A method and a molded part of the initially mentioned type are known from DE-U1-296 18 639. The primary molded part has an essentially circular through-opening in which are formed two segments of a single thread course of uniform pitch. The two opposing segments each extend over a span angle of 170° and thus form a nearly complete thread course. The internal thread is molded using two mold cores that are separated from one another along the surface of the thread cores and mold the segments as well as the two adjacent portions of the opening. For release from the mold, the two mold cores can be withdrawn in opposite axial directions without to much time or effort. This known method is not suitable for the manufacture of molded parts having two or more adjacent thread courses.

### SUMMARY

The object of the invention is to provide a simple and economical method of the initially mentioned type that is suitable for the primary molding of internal threads with great axial length. It is another object of the invention to create a molded part with internal threading that is simple to manufacture by primary molding and is suitable for relatively high loads.

In accordance with the invention, the object with respect to the method is attained by the features of claim 1 and the object with respect to the molded part is attained by the features of claim 9. Advantageous embodiments of the method and molded part are specified in the dependent claims associated with each of these claims.

The inventive method provides that the at least two segments of the internal thread are formed by mold cores, which project into the opening in the molded part through the circumferential wall of said opening and are withdrawn from the molded part radially with respect to the longitudinal axis of the internal thread for release from the mold. As a result of the inventive arrangement of the mold cores, a plurality of adjacent segments of a thread course or multiple thread courses of an internal thread can be molded in a simple manner. In this context, each mold core can form one or more segments of a thread course in a sector, and one or more mold cores can be provided to form the thread courses of a sector. In this way, it is possible to produce a molded part with an internal thread of great length with the sole limitation that the course or courses of the internal thread are not continuous in their extent, but instead are limited in each sector to segments that extend over only a part of the circumference of the opening. However, since the segments are arranged in different, preferably opposing sectors of the opening, an extent of segments covering 360° circumference can be achieved with respect to the overall length of an internal thread so that a threaded stud or screw is fully encompassed by the internal thread, and large retention forces can be transmitted.

It is also advantageous that the molded part can be released from the mold quickly, and no time is needed to unscrew a core that has a continuous external thread. The elimination of an unscrewing mechanism for the core makes the molding tool more compact and less costly. It has also proven beneficial that the radial mold cores produce eddies during filling of the mold, thereby achieving a good void-free structure of the molded part without flow lines.

Another proposal of the invention provides that the mold cores for forming axially adjacent segments of the internal thread rest tightly against one another inside the opening of the molded part. This prevents material from penetrating between the mold cores in the area of the opening of the molded part during the molding process.

Another proposal of the invention provides that the axial boundary surfaces which delimit the mold cores in the direction of the longitudinal axis of the opening are inclined to the longitudinal axis of the opening at an angle corresponding to the pitch angle of the internal thread. This achieves optimal utilization of the axial width of the mold cores to achieve the greatest possible overall length of the segments of the internal thread. Preferably, the region of a mold core that forms one or more segments of the internal thread extends over a sector of the internal thread of up to 180°. If the material used for primary molding permits forced mold release of slightly undercut regions, as do many thermoplastics for example, the region of the mold core that forms one or more segments of the internal thread can extend over a sector of the internal thread of greater than 180°, in particular from 230° to 250°.

It is useful for the mold cores that form axially adjacent segments of the internal thread to each be arranged in a different sector of the internal thread, for example for two adjacent mold cores to be arranged on opposite sides of the opening. If the plane of separation of the mold is perpendicular to the radial extent of the mold cores in such an arrangement of the mold cores, the mold cores can be permanently anchored in the two mold halves and can be removed from the molded part together with the mold halves when the mold is opened. If a different division of the mold is provided, or if the mold cores are arranged at an angular spacing of 120°, for example, then the mold cores must be designed as slides that are withdrawn from the molded part prior to the opening of the mold.

The molded part produced according to the inventive method by primary molding has an opening and, formed in the opening, an internal thread that has at least two segments of a course of thread located in different sectors, wherein a core opening is opposite each of the at least two segments of the internal thread, which opening radially penetrates, in an outward direction, the wall surrounding the opening. The molded part designed according to the invention is not only very simple to produce, but is also characterized by a number of additional advantages. Thus, the borders or edges of the radial core openings can serve to strip material adhering to the surface of a stud or screw, such as paint, undercoating, wax or dirt, and accommodate it in the core openings, so that the screw-on process is not impeded by this material and damage to the internal thread is avoided. The stripping action is especially effective when the core openings are matched to the thread pitch.

The inventive molded part can be designed to be symmetrical or asymmetrical. The inventive molded part preferably constitutes a nut that has a tool engagement region on its outer surface, in particular a hexagon, that is coaxial to the internal thread. In addition, a flange to create a larger contact area can be molded on the side of the nut intended for contact with a component.

If the molded part is manufactured out of plastic as a nut in order to be assembled with a welding stud and welded, the radial core openings provide an advantageous opportunity to access the welding stud inside the nut and deliver the welding current to the welding stud with the aid of tongs engaging in the core openings.

In accordance with the invention, there can be provided between one axial end of the opening and the internal thread of the molded part a lead-in area with an outwardly increasing cross-section to facilitate the introduction of a threaded stud or screw. The lead-in area can have a circular or oval basic shape which tapers conically inward and thus creates a free space for accommodating welding residue produced at the joint when a welding stud is welded on. If the lead-in area is designed to be out of round, this makes it easier for excess material at the weld joint to dig into the material of the molded part when the part is made of plastic, for example. The shape of a polygonal truncated pyramid can also be useful to produce the lead-in area.

According to another proposal of the invention, there can be provided in the lead-in area or in a centering area between the lead-in area and the internal thread, detent bosses shaped such that they effect a snap-on anchoring on the external thread of a threaded stud or screw intended to be screwed into the molded part. These detent bosses make it possible to preassemble the molded part on a stud or screw by axially pushing them together. The detent bosses, which have a uniform circumferential spacing, are preferably offset in the axial direction to match the pitch of the internal thread so that they effect a precentering and alignment of the external thread in the first course of the internal thread when snapped onto the external thread of the stud or screw.

The other end of the opening of the molded part opposite the lead-in area can be closed or open in design. If this end of the opening is of open design, the internal thread can be adjoined by a self-locking area that is formed by a cylindrical or prismatic core opening, coaxial to the internal thread, into which will cut the external thread of a stud or screw associated with the internal thread. At least one groove extending in the longitudinal direction can be provided in the wall of the core opening, forming stripping edges which clean the external thread of a stud or screw passing through the core opening during unscrewing. The groove preferably terminates in a radial core opening so that the material removed during this cleaning process can be accommodated in said opening and carried outward through it.

The segments of the internal thread of the molded part preferably extend over a sector of the opening of 180°. If the molded part consists of a material, for example plastic, that permits forced release of mold cores, the segments of the internal thread can extend over a sector of the opening of greater than 180°, in particular 230° to 250°.

### DRAWINGS

The invention is described in detail below on the basis of example embodiments that are shown in the drawings. The drawings show:

FIG. 1 is a side view of a hex nut made of plastic;

FIG. 2 is a top view of the nut from FIG. 1, analogous to FIG. 4;

FIG. 3 is a cross-section of the nut along the section plane III-III in FIG. 2;

FIG. 4 is a side view of the nut labeled A in FIG. 1;

FIG. 5 is a cross-section V-V of the nut from FIG. 2;

FIG. 6 is a side view of the nut labeled B in FIG. 1;

FIG. 7 is a cross-section VII-VII of the nut from FIG. 2;

FIG. 8 is a cross-section through a mold for primary molding of a nut according to the invention;

FIG. 9 is a view of the flange side of the plastic anchor;

FIG. 10 is a cross-section X-X of the anchor from FIG. 9;

FIG. 11 is a cross-section XI-XI of the anchor in FIG. 10; and

FIG. 12 is a cross-section XII-XII of the anchor from FIG. 9.

### DETAILED DESCRIPTION

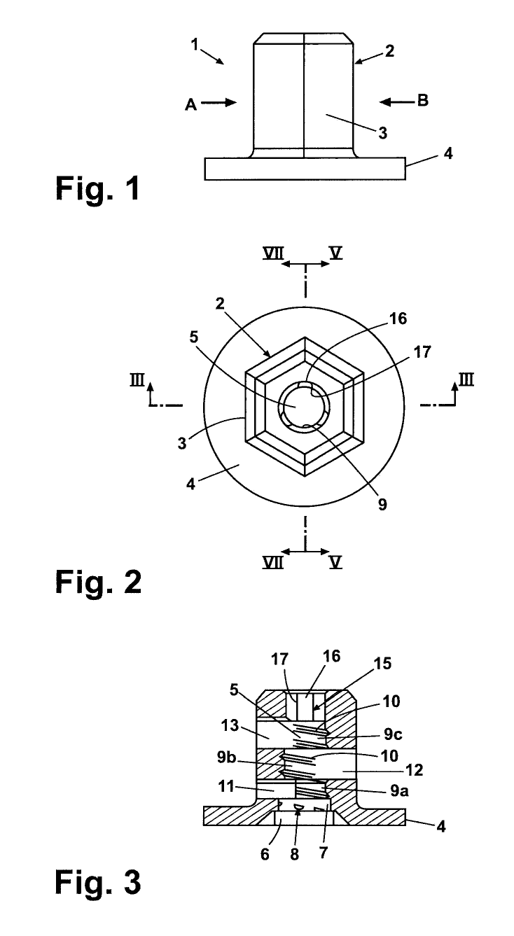

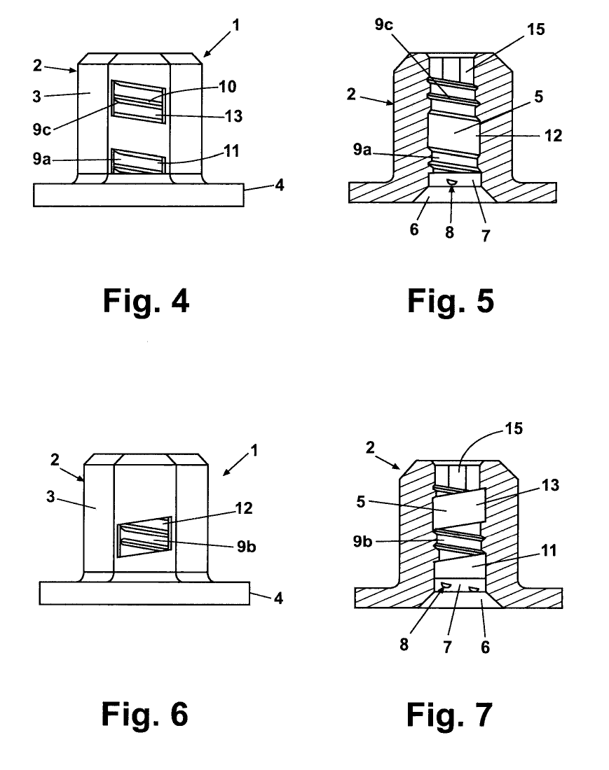

The nut 1 shown in FIGS. 1 through 7 is a one-piece molded part made of plastic through primary molding in the injection molding process. The nut 1 has a body 2 with an external contour in the shape of a hexagonal prism, which forms a tool engagement region 3. Formed on the end face of the body 2 is a disk-shaped flange 4. A central, through opening 5 for accommodating an externally threaded stud extends through the nut 1 in the longitudinal direction of the hexagonal prism. The opening 5 is subdivided into multiple regions of different shapes.

On the flange side, the opening 5 forms a lead-in area 6, in the form of an oval lead-in opening that tapers inward from a relatively large entry cross-section to a smaller connecting cross-section. The sloped boundary surfaces of the lead-in area 6 have an angle relative to the longitudinal axis of the nut 1 of approximately 45°.

Continuing inward, the lead-in area 6 is adjoined by a cylindrical centering area 7 with detent bosses 8 that project radially inward. The diameter of the centering area 7 is approximately equal to, or slightly larger than, the outside diameter of the stud to be accommodated. The detent bosses 8 are arranged along a helical line at regular intervals from one another in the circumferential direction, with the pitch of the helical line being the same as the pitch of the stud's thread. The size and number of the detent bosses 8 are chosen such that the free end of a stud intended to be screwed into the nut 1 can be pressed into the centering area 7 by axial movement, in which process the detent bosses 8 jump over the crest of a thread course and snap into the following thread groove, thereby holding the stud in the centering area 7 of the nut 1. Moreover, the detent bosses 8 position the external thread of the stud in the centering area 7 such that the external thread is easily threaded into the internal thread 9 of the nut 1 adjacent to the centering area 7.

The internal thread 9 in the opening 5 has three sections 9a, 9b, 9c which are separated from one another for manufacturing reasons. Each section 9a, 9b, 9c contains segments 10 of a single thread course, which extend over a sector of the opening 5 of approximately 230°. The segments 10 of the sections 9a and 9c are arranged in the same sector of the opening 5. The segments 10 of the section 9b, in contrast, are located in a sector of the opening 5 that is diametrically opposite the sectors of the sections 9a, 9c. Opposite each of the segments 10 of the sections 9a, 9b, 9c is located a core opening 11, 12, 13 which radially penetrates the wall of the body 2. The core opening 11 adjacent to the flange 4 has a trapezoidal cross-section, while the two other core openings 12, 13 have a cross-section in the shape of a parallelogram. The inclination of the surfaces of these cross-sections, which are inclined with respect to the longitudinal axis of the nut 1, matches the pitch of the internal thread 9. The core openings 11, 12, 13 have a cross-section that is constant or increases slightly from inside to outside such that the mold cores located therein during primary molding of the nut 1 can easily be removed from the mold. The intersections of the core openings 11, 12, 13 with the opening 5 form stripping edges, which strip off material such as paint or dirt adhering to the surface of a stud or screw when it is screwed in so that the material does not reach the thread segments. Here, the core openings 11, 12, 13 serve as chambers to accommodate the stripped-off material.

On the side of the nut 1 opposite the flange, the internal thread 9 is adjoined by a self-locking area 15. The self-locking area 15 has a smooth, cylindrical bore whose inside diameter is smaller than the outside diameter of the stud or screw thread. In addition, located in the bore wall with a separation of 120° are three longitudinal grooves 16 which, at the intersection with the bore wall, form stripping edges 17 that are parallel to the axis. The external thread of a stud or a screw cuts into the self-locking area 15, during which process the part of the body 2 surrounding the self-locking area experiences a slight elastic expansion. As a result of this elastic expansion, the self-locking area 15 rests against the external thread of the stud or screw with radial preloading, thereby producing a frictional engagement which keeps the nut 1 from coming loose from the stud. The purpose of the longitudinal grooves 16 with the stripping edges 17 is to clean the end of a stud or screw projecting out of the nut 1 when the nut 1 is unscrewed.

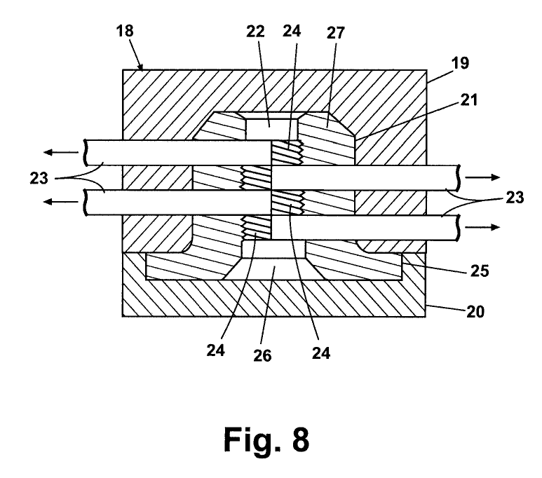

FIG. 8 shows a cross section of a molding tool 18 for primary molding of a nut of plastic using the inventive method. The molding tool consists of a top part 19 and a bottom part 20, which in the arrangement shown for manufacturing a molded part rest tightly against one another and are held firmly together by retaining means which are not shown. The top part 19 has a mold opening 21 that corresponds to the outer contour of the body 2 of the nut. Projecting from above into the mold opening 21 is a core part 22, which forms the top end, for example a self-locking area, of the opening that extends through the nut. Also projecting into the mold opening 21, from opposite sides, are mold cores 23, which serve to form the individual segments of the internal thread of the nut. The mold cores 23 have a rectangular cross-section and are movably mounted in wall openings of the top part 19 so as to be radially movable with respect to the mold opening 21. The mold cores 23 are arranged offset relative to one another in the direction of the longitudinal axis of the mold opening 21, and at their inner ends. Their surfaces which intersect the longitudinal axis rest directly against one another, with a mold core on one side alternating with a mold core on the opposite side in each case. The inner ends of the mold cores 23 have a hemi-cylindrical basic shape and are provided with segments 24 of an internal thread. Each of the segments 24 extends over a sector of 180°. The bottom part 20 has a recess 25 that serves to mold the flange adjoining the body of the nut. Located in the center of the recess 25 is a core part 26, which has a section in the form of a truncated cone and a cylindrical section, and which forms the lead-in and centering areas of the nut opening. The core parts 22 and 26 rest directly against the mold cores 23 adjacent to them.

A nut 27 is formed by the injection of softened plastic into the cavity enclosed by the molding tool 18. To release the nut 27 from the mold, the mold cores 23 are pulled radially outward out of the mold opening 21. The bottom part 20 of the molding tool is separated from the top part 19, and then the nut 27 is ejected from the top part 19 by means that are not shown in detail. In this way, the manufacturing process described makes possible the fast and economical manufacture of a plastic nut with preformed internal thread that is characterized by the advantages described above.

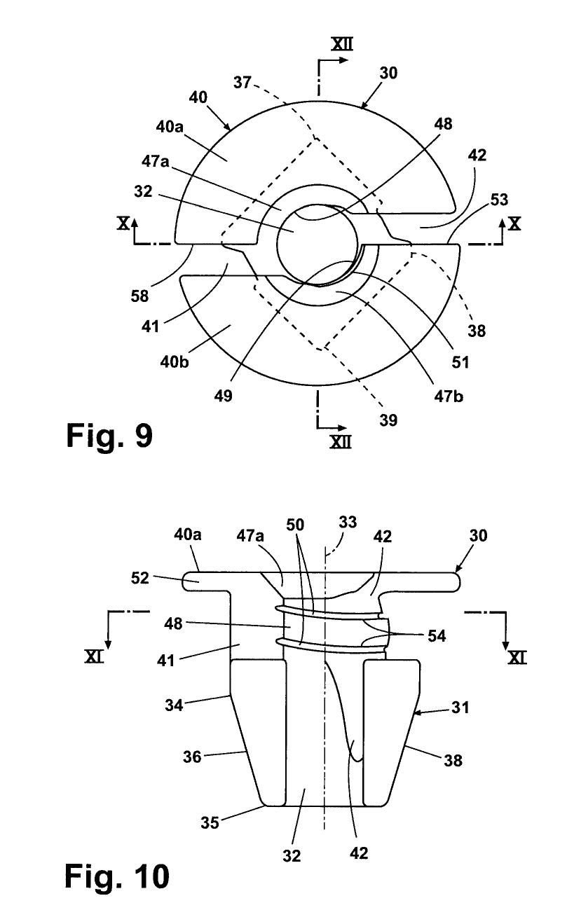

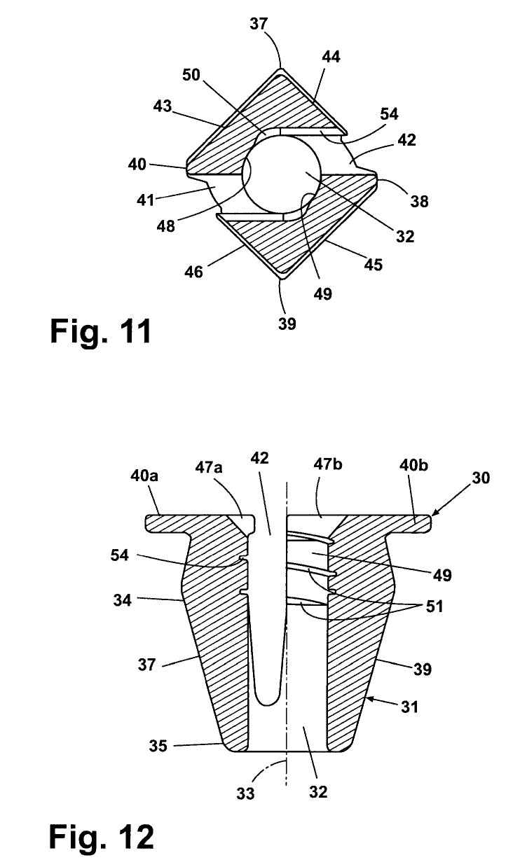

FIGS. 9-12 show an anchor 30, which is primary molded of plastic in a single piece using the injection molding process. The anchor 30 has a shank 31, which is penetrated in the longitudinal direction by a cylindrical opening 32 with a longitudinal axis 33. The shank 31 has a square outer contour intended for insertion and fastening of the anchor 30 in a square hole in a component. The outer contour has its greatest radial extent in a center region 34 of the shank 31. Between the center region 34 and an insertion end 35 of the anchor 30, the surfaces and the corners 36, 37, 38, 39 of the outer contour are inclined relative to the longitudinal axis 33 such that the shank 31 tapers toward the insertion end 35. The end of the shank 31 opposite the insertion end 35 has a flange 40 projecting beyond the outer contour which is divided into two halves 40a, 40b by slots 41, 42. The flange 40 has a circular outer contour, but can instead also have a polygonal contour, for example square or hexagonal. Between the center region 34 and the flange 40, the outer contour of the shank 31 is likewise slightly tapered toward the flange 40 by inclination of its surfaces 43, 44, 45, 46 relative to the longitudinal axis 33, in order to achieve better anchoring of the anchor in the hole provided for this purpose in a component. To facilitate insertion of a screw in the opening 32, the wall of the opening in the vicinity of the flange 40 is adjoined by surface sections 47a, 47b which coincide with the lateral surface of an outwardly expanding cone.

The slots 41, 42 extend in the longitudinal direction of the shank 31 beyond the center region 34 to the vicinity of the insertion end 35 and divide the slotted section of the shank 31 into two halves which can be moved toward one another by elastic deformation of the unslotted insertion end 35 in order to more easily insert the anchor in a hole that is narrower than the cross-section of the center region 34. The regions of the slots 41, 42 closer to the flange 40 also serve as core openings in which mold cores are arranged during primary molding of the anchor 30. These mold cores extend into the opening 32 and form wall sections 48, 49 of the opening 32 and form recessed segments 50, 51 of a thread course in the wall sections 48, 49. To this end, the slots 41, 42 are arranged on opposite sides of the section plane X - X, which they adjoin with a boundary surface 52 or 53, respectively. By this means, two mold cores for primary molding of segments of a thread course can be arranged in the same section of the opening 32, with the mold cores resting tightly against one another inside the opening section with contact surfaces extending along the section plane X-X. For release from the mold, the mold cores are withdrawn from the opening section and the adjoining slots 41, 42 in the radial direction along the section plane X-X. If the opening 32 has no segments of thread courses, it can also be formed by an axially removable cylindrical mold core.

As is evident from FIG. 10, each segment 50, 51 of a thread course adjoins a straight groove 54 leading outward in the slot, which is produced by the mold core and serves to create the free space necessary for releasing from the mold the ribs of the mold core which form the segments 50, 51.

It is also noteworthy that the plane X-X common to the slots 41, 42 is arranged diagonally with respect to the square form of the outer contour of the shank 31. As a result, the corners of the shank 31, which lie on the diagonal plane perpendicular to the plane X-X are fully formed, with the circumferential width of the wall surfaces 43, 45 adjoining the corners on one side remaining fully intact. By this means, the anchor can be supported in a square hole especially well and can transmit a comparatively high torque to the edges of the square hole.

Like the previously described example embodiments, the anchor 30 can also be manufactured quickly and economically with simple molding tools. The design with thread segments located opposite one another in the same section of the opening has the advantage that even components with small axial lengths can be provided with adequately long threaded sections using the inventive method. Moreover, the circumferential expansion of the slots is reduced, which is extremely advantageous for many components, as the above-described anchor demonstrates.

The method described for primary molding of segments of internal threads is also suitable for numerous additional applications in addition to the example embodiments described. Thus clips, pipe and cable clamps, and other fasteners that are provided with an internal thread can be produced in the described manner to advantage.

What is claimed is:

1. A molded part produced by primary molding, comprising:
a part body having a through opening with a wall defined by the opening;
an internal thread created in the wall of the opening having at least two segments of a course of the internal thread located in different sectors of the opening;
the sectors spatially separated by first and second slots created transverse to the opening and radially penetrating, in an outward direction, the segments having the internal thread; and
a flange radially outwardly extending from a first end of the part body, with the opening extending through the flange.

2. The molded part according to claim 1, wherein the part body has a rectangular shaped portion.

3. The molded part according to claim 2, wherein the first and second slots each extend through both the body and the flange.

4. The molded part according to claim 3, wherein the part body includes a tapered shank portion with surfaces tapering from the rectangular shaped portion away from the flange and toward an insertion end.

5. The molded part according to claim 1, further comprising a lead-in area at an entry end of the opening having an outwardly increasing cross-section.

6. The molded part according to claim 5, wherein the lead-in area has a circular shape.

7. The molded part according to claim 1, comprising axial boundary surfaces delimiting contact surfaces for a plurality of mold cores insertable and removable in a direction tangential to a longitudinal axis of the opening for insertion and removal of the plurality of mold cores, the mold cores operable to create the internal thread.

8. A molded part, comprising:
a single piece polymeric anchor, the anchor having a shank penetrated in a longitudinal direction by a cylindrical opening with a longitudinal axis;
an outer contour of the anchor having a greatest radial extent located at a center region of the shank;
an insertion end of the anchor, wherein between the center region and the insertion end a plurality of surfaces define an outer contour, the surfaces of the outer contour being inclined relative to the longitudinal axis such that the shank tapers toward the insertion end;
an end of the shank opposite the insertion end includes a flange projecting beyond the outer contour, the flange divisible into two halves by first and second slots; and
a plurality of wall sections of the opening having recessed segments of a thread course in individual ones of the wall sections created by a plurality of regions of the slots proximate to the flange defining core openings in which at least two mold cores are operably arranged during primary molding of the anchor, the mold cores extending into the opening to form the wall sections of the opening and the recessed segments of the thread course.

9. The molded part of claim 8, wherein the slots are arranged on opposite sides of a section plane adjoining a boundary surface.

10. The molded part of claim 9, wherein two of the at least two mold cores for molding of segments of the thread course are positionable in a same section of the opening.

11. The molded part of claim 10, wherein an exit is defined in a radial direction along a section of the plane for release of the mold cores from the opening of the mold.

12. The molded part of claim 8, wherein the shank has a square outer contour adapted for insertion and fastening of the anchor in a square hole of a component.

13. The molded part of claim 8, wherein the flange has a circular outer contour.

14. The molded part of claim 8, wherein the flange has a polygonal contour.

15. The molded part of claim 8, wherein between the center region and the flange, the outer contour of the shank is tapered toward the flange by inclination of the surfaces relative to the longitudinal axis.

16. The molded part of claim 8, further comprising:
a wall of the opening in the vicinity of the flange; and
surface sections adjoining the wall defining a lateral surface of an outwardly expanding cone.

17. The molded part of claim 8, wherein the slots extend in the longitudinal direction of the shank beyond the center region and proximate to the insertion end and operably divide the slotted section of the shank into two halves movable toward one another by elastic deformation of an unslotted insertion end.

18. A method for molding a molded part having an opening and an internal thread formed in the opening having segments of a course of thread located in at least two different sectors, the method comprising:
forming the segments of the internal thread by a plurality of mold cores projecting into the opening;
projecting the mold cores through a circumferential wall of the opening; and
withdrawing the mold cores from the molded part radially with respect to a longitudinal axis of the internal thread to permit release of the molded part from the mold.

19. The method according to claim 18, comprising arranging the mold cores on opposite sides of the opening.

20. The method according to claim 19, comprising arranging two mold cores in a same axial section of the internal thread on opposite sides of a plane in which an axis of rotation of the internal thread lies.

21. The method according to claim 18, comprising extending a region of the mold cores that forms the segments of the internal thread over a sector of the opening of 180°.

22. The method according to claim 18, comprising extending a region of the mold cores that forms the segments of the internal thread over a sector of the opening greater than 180°.

23. The method according to claim 18, comprising extending a region of the mold cores that forms the segments of the internal thread over a sector of the opening ranging from 230° to 250°.

24. The method according to claim 18, comprising producing axial end sections of the opening lacking an internal thread by unthreaded mold cores that are axially releasable.

25. The method according to claim 18, comprising pressing the mold cores for forming axially adjacent segments of the internal thread tightly against one another inside the opening of the molded part.

26. The method according to claim 18, comprising inclining axial boundary surfaces of the mold cores with respect to a longitudinal axis of the opening at an angle corresponding to a pitch angle of the internal thread.
